(19) United States
(12) Patent Application Publication
(10) Pub. No.: US 2003/0077096 A1
(43) Pub. Date: Apr. 24, 2003

(54) Image output apparatus and method

(76) Inventors: Michael Potter, Hampshire (GB); Robert Truman Shillito, Somerset (GB); Andrew Francis Wallis, Bath (GB); Anthony William Harris, Berkshire (GB)

Correspondence Address: Oliff & Berridge, PO Box 19928, Alexandria, VA, 22320, US

(21) Appl. No.: 10/149,606

(22) PCT Filed: Nov. 7, 2001
(86) PCT No.: PCT/GB01/04951

(30) Foreign Application Priority Data
Nov. 10, 2000 (GB) 0027581.8

(51) Int. Cl. G03G 21/00

(52) U.S. Cl. 399/366

(57) ABSTRACT

Image output apparatus comprising a marking engine (3); and a marking engine control system (2) for supplying data defining an image in a suitable format to the marking engine to cause the marking engine to output the image. The marking engine control system includes a system for: 1) determining from the data defining the image, or from the condition of the marking engine control system, whether the marking engine could output an image of a predetermined type which is not to be output, and if it could not, controlling the marking engine to output the image; and 2) if it is determined in step 1) that the marking engine could output an image of the predetermined type, determining from the data defining the image whether the image includes image characteristics indicating that the image is of the predetermined type; and controlling the marking engine to output the image only if the image is determined no to be of the predetermined type.

The invention relates to image output apparatus comprising a marking engine and to a method of controlling a marking engine.

Photocopiers, printers and other image reproduction devices are becoming more and more sophisticated as manufacturers attempt to enable much more accurate reproductions to be generated. However, there are certain types of document, for example documents of value, where accurate reproduction is undesirable for obvious reasons. There have therefore been many attempts in the past to prevent reproduction of such documents. These have included incorporating into the documents certain security features such as optically variable devices and the like. In addition to this, security document manufacturers have worked with photocopier manufacturers to devise methods which enable a photocopier to recognise that it has been presented with a document of value which should not be reproduced and then to stop the reproduction process. Typically, this has involved incorporating certain codes such as watermarks and the like into the documents, the photocopier attempting to look for the code or watermark on each occasion on which it carries out a copying process.

Examples of prior art describing these approaches include WO00/07356, WO99/53428, EP-A-0917113, DE-A-19800316, U.S. Pat. No. 5,949,903, EP-A-0675631, EP-A-0946039, EP-A-0940780, EP-A-0585724, EP-A-0382549, EP-A-0440142, EP-A-0529746, U.S. Pat. No. 5,367,577, EP-A-0522769, EP-A-0485694, EP-A-0067898, and EP-A-0342060.

As can be seen from the large number of prior art documents listed above, many different variations on this approach have been put forward. This leads to a highly complex authorising process if a photocopier or other reproduction apparatus is to be able to prevent reproduction of most documents of value since it will need to look for a wide variety of protection marks.

In accordance with a first aspect of the present invention, a method of controlling a marking engine in response to data defining an image so as to prevent the output of an image of a predetermined type comprises

1) determining from the data or from the condition of the marking engine control system, whether the marking engine could output an image of the predetermined type, and if it could not, controlling the marking engine to output the image;

2) if it is determined in step 1) that the marking engine could output an image of the predetermined type, determining from the data defining the image whether the image includes image characteristics indicating that the image is of the predetermined type; and controlling the marking engine to output the image only if the image is determined not to be of the predetermined type.

In accordance with a second aspect of the present invention, image output apparatus comprises a marking engine; and a marking engine control system for supplying data defining an image in a suitable format to the marking engine to cause the marking engine to output the image, the marking engine control system including apparatus for:

1) determining from the data defining the image, or from the condition of the marking engine control system, whether the marking engine could output an image of a predetermined type which is not to be output, and if it could not, controlling the marking engine to output the image; and

2) if it is determined in step 1) that the marking engine could output an image of the predetermined type, determining from the data defining the image whether the image includes image characteristics indicating that the image is of the predetermined type; and controlling the marking engine to output the image only if the image is determined not to be of the predetermined type.

We have developed a new approach to this problem. In particular, we have realised that there are many types of document carrying images which could not constitute images of the predetermined type, and if such an image can be detected initially during step 1 then there is no need for the reproduction apparatus to go on to determine whether certain specific codes or the like are present. Examples of “images of the predetermined type” include images on documents of value such as banknotes. Of course, there may be more than one predetermined type of image, for example each denomination in a series of banknotes.

In addition, the condition in which the marking engine control system is set can be used to determine if the image to be output cannot be of the predetermined type.

For example, step 1 may comprise determining if the condition of the marking engine control system is one or more of the following: set to allow colour output, and set with an output resolution greater than a predetermined value. Alternatively, or additionally, step 1 may comprise determining from the data defining the image one or more of the following: whether the image is defined as a colour image, whether the resolution of the image is greater than a predetermined value, whether the size of a file containing the data defining the image exceeds a predetermined value (for example 50 kB), and whether the size of the image falls outside a predetermined range. If more than one of these is determined this may be done sequentially or in parallel. Furthermore, the tests could yield pass/fail decisions or probability outcomes. For example, fuzzy logic could be employed with the results of a number of tests being “weighted” and combined to give an overall estimate of the probability of an image being (or containing) a banknote or other prohibited image.

If step 1 fails in the sense that it remains possible that an image of the predetermined type could be output by the marking engine then the method transfers to step 2. In this step, the data defining the image itself is reviewed to look for certain image characteristics.

Optionally, step 2 can be broken down into two substages. In one substage step 2 comprises determining from the data defining the image one or more of the following: whether the image has characteristics of a photograph, whether the image includes half-tones, and whether the image includes more than a predetermined level of text. This may utilize a probability approach to identify candidates which are much less likely to be documents of value.

Subsequent to this substage (or in place of it) step 2 may comprise determining one or more of the following:

whether the size of the image corresponds to a predetermined size,

whether the hue of a specified part of the image corresponds to a predetermined hue,

whether the image includes line-work of a predetermined nature,

whether the image includes a specified feature,

whether the image has a denomination numeral printed in a predetermined font,

whether the name of a bank is present in a predetermined font,

whether there is a “typical” engraved portrait image,

whether serial numbers are present in a predetermined font,

whether the characteristic colours caused by scanning a hologram- or kinegram-like element are present,

whether there are (or are not) specific printed features present,

whether the characteristic pattern of a scanned security thread is present,

whether the image has a certain “texture” (as determined by one or more techniques well known to those skilled in the art, e.g. Discrete Wavelets Frames Analysis, Hidden Markov Chain Analysis, etc.),

whether the spatial frequency characteristics of the image (determined by one or more techniques well known to those skilled in the art, e.g. Haar Wavelet Analysis, Debauchie Wavelet Analysis, Discrete Cosine Transform Analysis, Fourier Transform Analysis, etc.) are (or are not) of a predetermined nature, and

whether specific paper features (fibres, planchettes, etc.) are present.

In this approach, specific attributes of images which are strongly indicative of documents of value which should not be reproduced are looked for.

In accordance with a third aspect of the present invention, a marking engine control system comprises apparatus for:

1) determining from data defining an image to be output, or from the condition of the marking engine control system, whether the marking engine could output an image of a predetermined type which is not to be output, and if it could not, controlling the marking engine to output the image; and

2) if it is determined in step 1) that the marking engine could output an image of the predetermined type, determining from the data defining the image whether the image includes image characteristics indicating that the image is of the predetermined type; and controlling the marking engine to output the image only if the image is determined not to be of the predetermined type.

The invention also relates to a computer program product such as a memory which stores a marking engine control system and to a computer program embodying the marking engine control system.

In general, if it is determined that a document of the predetermined type could be output, the output process is aborted. Alternative measures include:

overprinting the output image,

degrading the output image, for example by reducing the resolution,

outputting only part of the image,

outputting the image in one colour or fewer than full colour, or

causing a “General Protection Fault” to “crash” the application.

Many other possibilities exist.

Although this invention is primarily concerned with preventing the output of images of a predetermined type, the logic can be reversed so as to allow only the output of images of the predetermined type.

Some examples of methods and apparatus according to the present invention will now be described with reference to the accompanying drawings, in which:

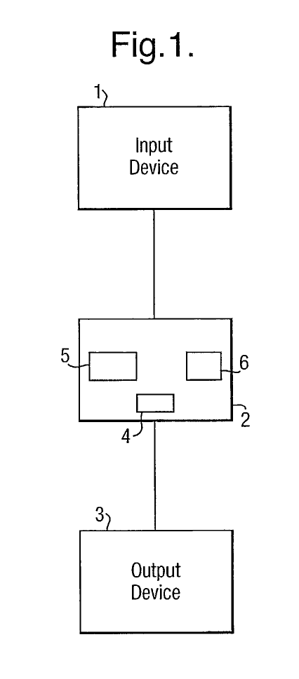

FIG. 1 is a schematic block diagram of the apparatus;

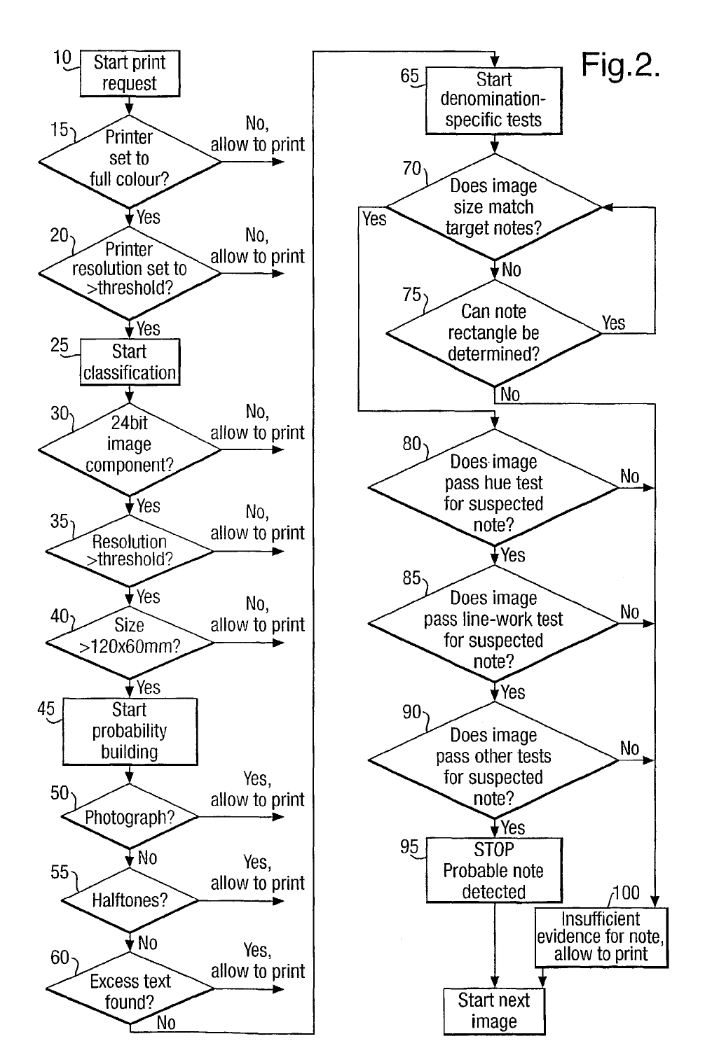

FIG. 2 is a flow diagram illustrating one example of operation of the apparatus shown in FIG. 1; and,

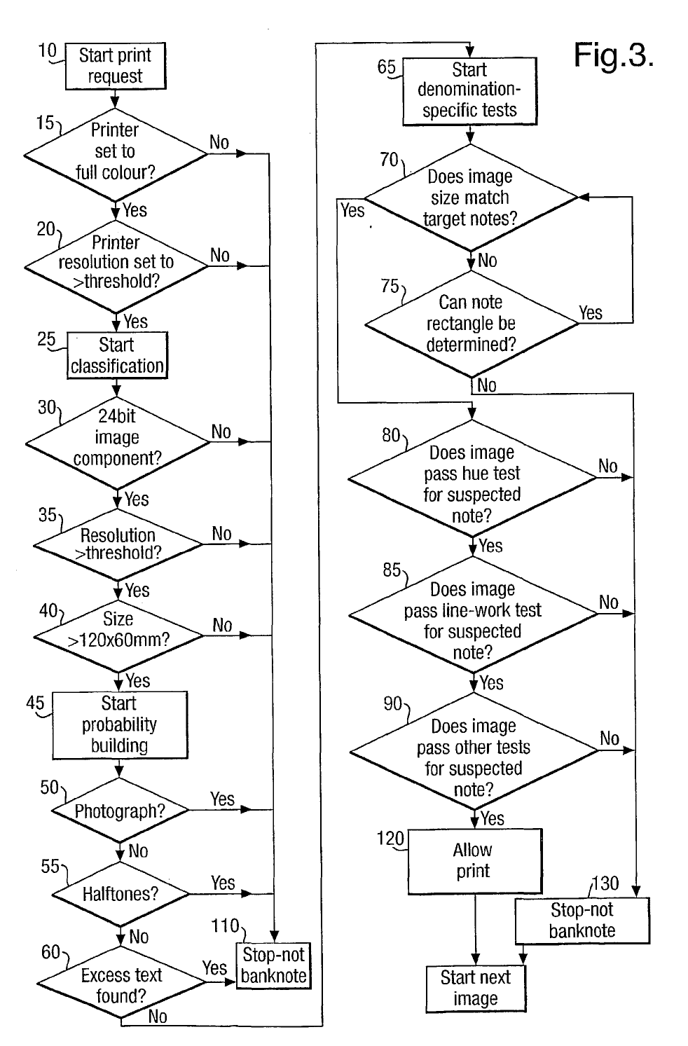

FIG. 3 is a flow diagram illustrating a second example of operation of the apparatus shown in FIG. 1.

FIG. 1 illustrates a generally conventional reproduction apparatus including an input device 1 such as a scanner, a processor module 2 such as a PC attached to the scanner 1 for processing digital image data received from the scanner, and a marking engine such as a printer 3 (laser, ink jet etc.). The processor module 2 includes a processor 4, a memory 5 storing printer driver control software and a memory 6 for storing image data. The printer driver control software may be a separate module or located wholly or partially within the processor 2 and printer 3.

The printer driver control software in the memory 5 converts scanned data defining the input image into data suitable for controlling the printer 3.

As will be appreciated, in this example we are describing application of the method to a PC based system. However, since in principle the printer driver and analysis module are completely different and separate, the invention is equally applicable to other image output systems such as digital presses and other printing devices. Examples include controllers in laser printers, colour copiers, inkjet printers and digital presses, PostScript and other raster image processors (RIP's) and printer drivers on UNIX, Linux, CE and other operating systems.

In use, a user places a document to be copied onto a scanning platen (not shown) of the scanner 1 and depresses a “print” button (not shown) (step 10) (FIG. 2).

The printer driver software includes control software for overriding the print command in a number of situations where it is determined that an attempt is being made to copy a prohibited type of document such as a document of value, for example a banknote. This will now be described with specific reference to banknotes.

Initially, the software determines whether the printer driver control software is adapted to output a full colour image, for example 24 bit (step 15). If the printer driver control software is not set to output full colour then the printing process is immediately allowed to take place. This is on the basis that banknotes will contain colour and any reproduction of a banknote which does also not accurately reproduce its colour will be immediately recognisable.

The printer driver control software then determines whether the output resolution is set greater than a predetermined level (step 20). Again, if the resolution is less than this predetermined level, it is assumed that the reproduction would not be sufficiently accurate to pass as a genuine document and the printing process is allowed to proceed.

If both tests 15 and 20 (or further tests not shown) are answered in the affirmative, then it remains possible that an accurate reproduction of a banknote could be produced. The printer driver control software therefore enters a classification process 25.

In step 30, the printer driver control software determines whether the image data which it is to supply to the printer is formed by a predetermined number of bits, for example 24 bit (or more) components. If it is not, then the colour of the reproduced image will not be an accurate representation of the original colours and consequently the reproduction will be detectable as such. The printer 3 can therefore be instructed to print the reproduction.

If the data does comprise 24 bit or more components then the printer driver control software determines whether the image is defined at more than a predetermined pixel resolution level (step 35). Again, if the resolution is less than the predetermined level then the reproduction can be permitted since it will be easily detectable.

Otherwise, the process moves on to step 40 which looks at the size of the expected reproduction. In the case of banknotes for example, these will typically have sizes greater than 120×60 mm and thus anything falling below this size could not be an accurate reproduction of a banknote.

If the expected size of the reproduction falls above the specified range in step 40, the process then enters a probability building process 45. It will be appreciated that the printer driver control software will have allowed the printing process to proceed with many different types of document and it is only those originals which have failed the various tests or if it has been determined that the printer is capable of accurate reproduction of a banknote that the process has reached stage 45.

In step 50, the printer driver control software reviews the image data to determine whether the original has characteristics corresponding to a photograph. Photographs of natural subjects generally show fairly smooth changes in hue and saturation and this characteristic may allow them to be differentiated from banknote images and eliminated from further tests. If it does, then the reproduction is permitted.

If it does not, the printer driver control software then looks to see whether the original contains half-tones (step 55). These can be detected by applying a threshold to the image data. Provided that the scan is a sufficiently high resolution (approximately three times the screen frequency, or greater), the half-tone is visually obvious and is detectable by using conventional image processing techniques.

Finally, in this probability building process, the printer driver control software looks to see whether there is a significant amount of recognisable text. If there is, then this indicates that the document is not a banknote and printing can be permitted. This is most conveniently achieved by using an OCR software module to attempt to identify text characters. The text level will be set as appropriate.

Finally, if all the tests described so far still result in the possibility that an accurate reproduction of a banknote could be generated, the process moves on to stage 65 where specific denomination tests are performed.

In a first test 70, the printer driver control software determines the actual size of the reproduced document from the image data, and compares this with one or more predetermined size sets stored in the memory 5. If there is a match (within tolerances) this suggests that the document is a banknote and processing passes to step 80.

If there is no match, step 75 determines whether or not one or more note rectangles can be determined. This can be difficult if a counterfeiter has attempted to foil the detection mechanism by placing the banknote against a coloured background or on a complex background or in a rotated position. If a rectangle can be determined, returns to step 70 otherwise it moves to step 80.

In any image, more than one possible note location may be detected. Of these possible locations either none or more may be actual banknote images. If more than one possible location is detected, the locations may be compared to detect mutually impossible pairs (e.g. where the notes would overlap) and this information could then be used by any downstream testing. If spurious tentative notes are detected at this stage, it is assumed that such (incorrect) detections will be rejected by the downstream testing.

At least three techniques of determining the location of a note are possible.

1 Image bounds.

2 Detect the extents of possible notes.

3 Detect the content of possible notes—either by regions or by “edges” within the image (i.e. not the extents of the notes).

The first of these is clearly very simple. If the overall image size corresponds to a known banknote size then it is a good candidate for a single banknote. This is a trivial case, but is so simple and quick to perform that it is worth testing for. It requires a list of known note sizes. The test could be extended for multiple banknotes butted together with a small margin. (Already described above in connection with step 70).

The other two techniques require the image to be processed to allow features of interest (i.e. content or edges) to be extracted from the rest of the image. One major consideration with the techniques that might be used to perform this task is the complexity of a typical banknote image (especially if a user has deliberately tried to disguise the note by modifying the image surrounding it). The algorithm needs to consider the overall shape of the image content and hence much of the detail will need to be removed.

The first stage is to discard hue information and hence convert the colour image to greyscale. Using a combination of hue and intensity information is an alternative.

At this stage, the image resolution can also be much-reduced. The lower the resolution, the faster any subsequent processing (but the accuracy of any location information is reduced).

This resolution-reducing stage may be combined with the removal of some thin-line image details. Rather than simply taking the average grey level of each block of pixels, the minimum grey level may be used. Since much of the content of many notes is in the form of thin-line rulings, taking the minimum value tends to convert many areas of rulings to solid colour. This happens for both black-line or white-line patterns. Note that this will also have the affect of widening any “dark” regions of the image (e.g. shadows, numbering etc). In practice a combination of average and minimum grey levels will be used.

In order to isolate features it is convenient to generate a bi-level image from the original colour image. This may be achieved by applying a threshold, fixed or adaptive, to the grey scale image at some chosen grey level so that all pixels are converted to black or white. White pixels in the image are assumed to correspond to:

background,

paper, or

“light” areas of the printed content.

Black pixels in the image are assumed to correspond to:

“dark” areas of the printed content (assumed to be of significant proportion of the printed content), or

shadows.

The success of any further processing is very dependent on how “clean” this image is. Assuming that there is little noise in the scanned image and that the artwork is clean (which is a reasonable assumption if the image does contain images of banknotes) then the major factors that affect the usefulness of the thresholded image are:

the threshold level,

the background.

Where the image changes from black to white, an edge is defined to occur. Pixels that contribute to an edge are easily detected in the image. The edge pixels may then be traced to generate a series of line segments that correspond to straight edges (some of which will be very short) in the image.

Note that the edge segments will be generated from a wide range of features in the original image. Some will correspond to the edges of a banknote, others to the edges of pattern regions within the note.

The simplest feature to detect from the edge segments are rectangular regions. These are relatively common in many images, including banknotes, once the image has been simplified as described above.

The edge segments previously found may be classified as to the (infinite) lines that they form part of (using a suitable tolerance). Possible “real” edges in the image may be determined by looking for regions on these lines that have a significant proportion of their length present in the edges derived from the image. Hence the many short edges formed by the content of any image may be removed from further consideration.

The orientation and spacing of these real edges may then be examined for possible rectangles (or partial rectangles). Such rectangles are detected by looking for two parallel real edges with another pair of perpendicular edges. Common line orientations can also be detected.

In order to detect possible locations for notes using extents, we assume that the notes to be detected are rectangular in shape and of known dimensions. We further assume that the edges of any note that has been scanned are either detectable due to shadows in the scanned image, or because the colour of the edges of the note is significantly different from that of the background.

Shadows are, in practice, difficult to avoid when scanning, but can easily be painted out by the forger.

When using the content of possible notes to detect possible locations, fewer assumptions are made and the user cannot modify the content of the note. It is likely that any image will contain several possible rectangles. All combinations of detected rectangles need to be compared with the stored list of known rectangular regions on the known set of notes to be detected in the memory 6. The relative locations of such regions may be used to determine the confidence of any possible detection.

In step 80, the processor 4 looks at the colours or hues which are to be reproduced. Modern banknotes tend to use one or more edge-of-gamut colours in fairly strong saturations and in step 80 the presence of such colours is determined. If such a colour is determined to be present, this suggests that a banknote is to be reproduced and processing moves to step 85. Otherwise, the image is printed (step 100).

In step 85, the printer driver control software looks to see whether certain line work is to be found in the original document by reviewing the scanned image data. Many banknotes incorporate intricate line work to prevent this from being accurately reproduced and in test 85, attempts are made to detect this, for example by pattern matching or the like. If such line work is detected, this suggests that the original document is a banknote and processing continues to step 90. Otherwise the image is printed (step 100).

Finally, one or more further tests may be carried out by the printer driver control software in step 90 so as finally to determine whether or not the document should be reproduced. This may include looking for watermarks or other codes within the document.

If sufficient of the tests indicate the likelihood that a banknote is to be reproduced, then the processor 4 inhibits the printing process (step 95). If there is insufficient evidence then the printing process is allowed to occur (step 100).

The steps 70-95 can be carried out in any order or in parallel.

The system described above operates to prevent the output or printing of certain images such as banknotes. As mentioned previously, the reverse system is also contemplated by the invention in which only images of the predetermined type are allowed to be printed. FIG. 3 illustrates the process in this case and it will be seen that this is an exact reverse of the process shown in FIG. 2. Each step in the process is the same as in FIG. 2 but the action adopted in response to the outcome is reversed. Thus, each step has been given the same reference numeral in FIG. 2 and will not be described further. If the outcome in any of steps 15-40 is “No” then the printing process is immediately stopped (step 110). Similarly, if the outcome of any of steps 50-60 is “Yes” then the printing process is stopped. Finally, only if the outcome of steps 70, 80, 85 and 90 are all “Yes” is the printing allowed to go ahead (step 120). If the outcome of any of these tests is “No” then the printing process is stopped (step 130).

1. A method of controlling a marking engine in response to data defining an image so as to prevent the output of an image of a predetermined type, the method comprising
1) determining from the data or from the condition of the marking engine control system whether the marking engine could output an image of the predetermined type, and if it could not, controlling the marking engine to output the image;
2) if it is determined in step 1) that the marking engine could output an image of the predetermined type, determining from the data defining the image whether the image includes image characteristics indicating that the image is of the predetermined type; and controlling the marking engine to output the image only if the image is determined not to be of the predetermined type.

2. A method according to claim 1, wherein step 1 comprises determining if the condition of the marking engine control system is one or more of the following: set to allow colour output, and set with an output resolution greater than a predetermined value.

3. A method according to claim 1 or claim 2, wherein step 1 comprises determining from the data defining the image one or more of the following: whether the image is defined as a colour image, whether the resolution of the image is greater than a predetermined value, whether the size of a file containing the data defining the image exceeds a predetermined value (for example 50 kB), and whether the size of the image falls outside a predetermined range.

4. A method according to any of claims 1 to 3, wherein step 2 comprises determining from the data defining the image one or more of the following: whether the image has characteristics of a photograph, whether the image includes half-tones, and whether the image includes more than a predetermined level of text.

5. A method according to any of the preceding claims, wherein step 2 comprises determining one or more of the following: whether the size of the image corresponds to a predetermined size, whether the hue of a specified part of the image corresponds to a predetermined hue, whether the image includes line-work of a predetermined nature, and whether the image includes a specified feature.

6. Image output apparatus comprising a marking engine; and a marking engine control system for supplying data defining an image in a suitable format to the marking engine to cause the marking engine to output the image, the marking engine control system including apparatus for:
1) determining from the data defining the image, or from the condition of the marking engine control system, whether the marking engine could output an image of a predetermined type which is not to be output, and if it could not, controlling the marking engine to output the image; and
2) if it is determined in step 1) that the marking engine could output an image of the predetermined type, determining from the data defining the image whether the image includes image characteristics indicating that the image is of the predetermined type; and controlling the marking engine to output the image only if the image is determined not to be of the predetermined type.

7. Apparatus according to claim 6, wherein the marking engine control system comprises a rendering engine for converting the data defining the image from a format unsuitable for the marking engine into a suitable format.

8. Apparatus according to claim 6 or claim 7, wherein the marking engine comprises an ink jet printer, laser printer/plotter, photocopier, digital press, multifunctional device, solid ink, thermal transfer or electrostatic printer.

9. Apparatus according to any of claims 6 to 8, wherein the marking engine comprises a printer and the marking engine control system comprises printer driver software.

10. Apparatus according to claim 9, wherein the printer driver software is located in a computer coupled to the printer.

11. Apparatus according to any of claims 6 to 10, adapted to implement a method according to any of claims 1 to 5.

12. A marking engine control system including apparatus for:
1) determining from data to be output defining an image, or from the condition of the marking engine control system, whether the marking engine could output an image of a predetermined type which is not to be output, and if it could not, controlling the marking engine to output the image; and
2) it it is determined in step 1) that the marking engine could output an image of the predetermined type, determining from the data defining the image whether the image includes image characteristics indicating that the image is of the predetermined type; and controlling the marking engine to output the image only if the image is determined not to be of the predetermined type.

13. A computer program product or computer program including a marking engine control system according to claim 12.

14. A computer program product or computer program according to claim 13, wherein the marking engine control system is incorporated in printer driver software.

15. A method of controlling a marking engine in response to data defining an image so as to allow only the output of an image of a predetermined type, the method comprising
1) determining from the data defining the image, or from the condition of the marking engine control system, whether the marking engine could output an image of the predetermined type, and if it could not, preventing the marking engine from outputting the image;
2) if it is determined in step 1) that the marking engine could output an image of the predetermined type, determining from the data defining the image whether the image includes image characteristics indicating that the image is of the predetermined type; and controlling the marking engine to output the image only if the image is determined to be of the predetermined type.

16. Image output apparatus comprising a marking engine; and a marking engine control system for supplying data in a suitable format defining an image to the marking engine to cause the marking engine to output the image, the marking engine control system including apparatus for:
1) determining from the data defining the image, or from the condition of the marking engine control system, whether the marking engine could output an image of a predetermined type which is to be output, and if it could not, preventing the marking engine from outputting the image; and
2) if it is determined in step 1) that the marking engine could output an image of the predetermined type, determining from the data defining the image whether the image includes image characteristics indicating that the image is of the predetermined type; and controlling the marking engine to output the image only if the image is determined to be of the predetermined type.

17. A marking engine control system including apparatus for:
1) determining from data to be output defining an image, or from the condition of the marking engine control system, whether the marking engine could output an image of a predetermined type which is to be output, and if it could not, preventing the marking engine from outputting the image; and
2) if it is determined in step 1) that the marking engine could output an image of the predetermined type, determining from the data defining the image whether the image includes image characteristics indicating that the image is of the predetermined type; and controlling the marking engine to output the image only if the image is determined to be of the predetermined type.
